(19) United States
(12) Patent Application Publication
(10) Pub. No.: US 2026/0149988 A1
(43) Pub. Date: May 28, 2026

(54) Methods and Systems for Physical Network Environment Evaluation

(71) Applicant: T-Mobile Innovations LLC, Overland Park, KS (US)

(72) Inventor: Timothy INDRIERI, San Ramon, CA (US)

(21) Appl. No.: 18/959,596

(22) Filed: Nov. 25, 2024

(51) Int. Cl. H04W 24/08; H04B 17/318; H04L 41/06

(52) U.S. Cl. CPC H04W 24/08; H04B 17/328; H04L 41/06

(57) ABSTRACT

A method comprises obtaining a signal parameter for each of a plurality of zones around a network element, wherein the signal parameter is a value representing of a strength of signals received by one or more user equipment (UEs) from a network element, wherein the one or more UEs are located in different zones around the network element, wherein each of the zones are geographic areas incrementally distanced from the network element, generating a vector for the network element, wherein the vector comprises the signal parameter for each of the zones, and computing a cosine similarity between the vector for the network element and a baseline vector associated with a second network element positioned in a cluttered environment to obtain a comparison parameter and determine a remediation action to perform with respect to the network element based on the comparison parameter.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A cell site is a network infrastructure that consists of antennas, radios, and supporting equipment, which transmits and receives radio signals to and from user devices. Cell sites enable wireless communication over a defined coverage area by connecting to a core network via a backhaul link to facilitate providing services, such as, for example, voice, data, and text messages to subscribed users.

The coverage area of the cell site is a geographic area where the radio signals of the cell site can effectively reach and provide service to mobile users. The coverage area of a cell site may be based on various factors, such as, for example, the frequency bands used, antenna height and power, terrain, and environmental factors. A cell site may provide strong and consistent signal strength across the coverage area, ensuring seamless connectivity and high-quality performance for users.

### SUMMARY

In an embodiment, a method implemented in a communication network to evaluate a performance of a cell site in a cluttered environment is disclosed. The method comprises identifying, by an application executing at a management system in the communication network, a location of the cell site in the communication network, determining, by the application, a plurality of zones around the cell site, in which one or more user equipment (UEs) are located in different zones around the cell site, and each of the zones are geographic areas incrementally distanced from the cell site, and obtaining, by the application, a quantity of sessions across one or more UEs located within each of the zones, in which each of the sessions in the quantity of sessions has a signal attribute value that meets a predefined threshold, and the signal attribute value is a reference signal received power (RSRP) value associated with each of the sessions and received from the one or more UEs. The method further comprises generating, by the application, a vector for the cell site, in which the vector comprises the quantity of sessions in each of the zones, computing, by the application, a cosine similarity between the vector for the cell site and a baseline vector to obtain a comparison parameter, in which the baseline vector includes values associated with a second cell site in a known cluttered environment, and instructing, by the application, performance of a remediation action based on a rule and on a comparison between the comparison parameter and a predefined threshold, in which the remediation action comprises transmitting an alarm to an alarm reporting system in the communication network.

In another embodiment, a management system comprises a memory, a processor coupled to the memory, and an application stored at the memory. The memory is configured to store a baseline vector comprising values representative of a known cell site experiencing signal degradation due to being positioned in a cluttered environment. The application, when executed by the processor, causes the processor to be configured to determine, based on a rule, an incremental distance to define a plurality of zones around a cell site, each zone comprising a geographic area extending from the cell site or an outer edge of a previous zone for the incremental distance, obtain a signal parameter for each zone, the signal parameter representative of a strength of signals received by one or more user equipment (UEs) from the cell site, and each of the one or more UEs are located in different zones around the cell site, generate a vector for the cell site comprising the signal parameter for each zone, obtain a comparison parameter based on a comparison between the baseline vector and the vector for the cell site, and instruct performance of a remediation action based on whether the comparison parameter meets or exceeds a predefined threshold.

In yet another embodiment, a method comprises obtaining, by an application executing at a management system, a signal parameter for each of a plurality of zones around a network element, the signal parameter being a value representing of a strength of signals received by one or more user equipment (UEs) from a network element, the one or more UEs located in different zones around the network element, and each of the zones are geographic areas incrementally distanced from the network element, generating, by the application, a vector for the network element comprising the signal parameter for each of the zones, and computing, by the application, a cosine similarity between the vector for the network element and a baseline vector associated with a second network element positioned in a cluttered environment to obtain a comparison parameter and determine a remediation action to perform with respect to the network element based on the comparison parameter.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a block diagram of a communication network for physical network environment evaluation according to an embodiment of the disclosure.

FIGS. 2A and 2B are diagrams illustrating a cluttered environment around cell sites in the communication network of FIG. 1 according to various embodiments of the disclosure.

FIG. 3 is a diagram illustrating a method of evaluating the environment of a cell site in the communication network of FIG. 1 according to various embodiments of the disclosure.

FIG. 4 is a flowchart of a first method of physical network environment evaluation according to various embodiments of the disclosure.

FIG. 5 is a flowchart of a second method of physical network environment evaluation according to various embodiments of the disclosure.

FIGS. 6A-B are block diagrams illustrating a communication system similar to the communication network of FIG. 1 according to an embodiment of the disclosure.

FIG. 7 is a block diagram of a computer system implemented within the communication network of FIG. 1 according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

As mentioned above, the coverage area of a cell site may be determined based on several factors, such as, for example, the frequency of the signals emitted by the cell site, the power of the signal transmission, the height of the antennas on the cell site, and the surrounding environment. For example, lower-frequency signals (e.g., 600 MHz to 2.5 GHz) may travel longer distances while higher-frequency signals (e.g., above 24 GHz) may provide higher data rates but may be more susceptible to environmental interference. The physical environment of the coverage area may significantly affect the propagation of signals to and from the cell site, thereby shaping the strength and quality of cellular coverage by the cell site. For example, tall buildings may block or reflect signals communicating to and from the cell site—creating shadow zones where the signal strength is reduced or even completely blocked. As another example, tall trees (e.g., dense foliage) may absorb and scatter the signals—leading to signal attenuation or weaker coverage in the surrounding area.

The physical, environmental obstructions in a coverage area are significantly more problematic when the obstructions are positioned proximate to the cell site (versus being farther away from the cell site but still within the coverage area). Specifically, obstructions that are positioned close to, immediately adjacent to, or touching the cell site (sometimes referred to herein as “cluttered cell sites”) may cause immediate and severe signal degradation. For example, the obstructions around these cluttered cell sites may block all signal paths between cell sites and user devices, leading to significant signal attenuation and creating zones of reduced signal coverage immediately around the tower (e.g., within 1 mile around the tower). In such a case, even the user devices relatively close to the cell site (which may otherwise be expected to receive the highest signal quality and strength) may be significantly affected by the cluttered environment of the cell site (e.g., resulting in dropped calls, reduced data rates, and overall poor service quality). On the other hand, when the physical obstructions are farther away but still within the coverage area of the cell site, the impact on the signals may be less pronounced (e.g., the signal degradation may be more gradual and manageable).

Meanwhile, mobile network operators (MNOs) may not have a system in place to detect when a physical environment immediately around or adjacent to a cell site is affecting the cellular coverage of the cell site. Rather, MNOs merely monitor the performance of deployed cell sites in the network, but otherwise ignore evidence indicating persistent poor coverage at cell sites, assuming that the persistent poor coverage is simply the expected coverage of the cell site (e.g., based on the expected interference, multipath propagation, weather conditions, network congestion, etc.). Said another way, MNOs may not deploy technicians or other operators to physically examine the coverage area around the cell site regardless of whether the cell site has been experiencing poor coverage or not, as such physical examinations are cost-prohibitive and unlikely to successfully resolve any issues. Moreover, many networks utilize an alarm and incident reporting system, in which cell sites programmatically transmit alarms to a network operations center (NOC) when software or hardware issues occur at the cell sites. Therefore, data indicative of signal coverage at a cell site (and across other NEs) may not be used effectively or efficiently, if used at all, to detect environmental clutter around cell sites. Therefore, these cluttered cell sites may continue to operate continuously with full power, regardless of the fact that these cluttered cell sites provide poor cellular coverage to devices connected to these cell sites. The MNO is also unaware of the environmental problem with the cell site. Therefore, the persistent use of cluttered cell sites is a significant waste of network and power resources, and significantly impacts the services provided to customers connected to these cell sites.

The present disclosure addresses the foregoing technical problems by providing a technical solution in the technical field of network performance management. In an embodiment, a management system may be communicatively coupled to the network elements (“NEs”) (e.g., cell sites and/or user equipment (UE)) in the network. The management system may receive signal attribute data from the NEs, and then use this data to determine whether the NEs are likely to be impacted by clutter proximate to or immediately adjacent to the NE, as further described herein. The term “clutter” as used herein may refer to physical obstructions that are positioned proximate to, touching, or immediately adjacent to the NEs (e.g., within a predefined distance from the NEs). Once the management system determines that an NE may be impacted by clutter, the management system may instruct the performance one or more remediation actions, as further described herein.

The management system may include an application and a data store. The data store may store various types of data, which may be evaluated by the application to identify cell sites that are affected by clutter and instruct remediation actions on those cell sites, when needed. For example, the data store may store NE data indicating an identifier and location of each of the NEs (e.g., an identifier and location of each of the cell sites in the network). The location may be formatted as Global Positioning System (GPS) coordinates or geohash values representing a relative location of the NEs. The NE data may also store signal attribute values received from the UEs served by the cell sites. A signal attribute value may refer to a value determined by the UEs and indicative of a strength and quality of the signals received by the UEs from the cell sites. For example, the signal attribute value may be a reference signal received power (RSRP) value, which may be a measurement computed by the UE that represents an average power level of reference signals received by the UE from a cell site. The data store may also store rules (e.g., logic, code, conditions, etc.), which may be programmed into the application, such that the application performs various tasks and/or processes based on the conditions indicated in the rules, as further described herein. One or more of the rules may specify predefined threshold values, as further described herein.

In an embodiment, one or more successive zones may be defined around each of the cell sites around the network, such that the signal strength at each zone is evaluated individually to determine whether a cell site is affected by clutter. A rule may indicate an incremental distance for each of the successive zones and a maximum distance, and the application may define the geographic area of each of the successive zones based on the incremental distance until the maximum distance is reached. For example, the first zone may be defined from a geographic area extending radially away from the cell site for the incremental distance, thereby creating a spherical zone around the cell site having a radius of the incremental distance. The second zone may be defined from a geographic area extending radially outward from the edge of the first zone for the incremental distance, the third zone may extend from a geographic area extending radially outward from the edge of the second zone for the incremental distance, and so on, until the maximum distance. As should be appreciated, one or more UEs or other devices/systems using the services provided by the cell site may be at least temporarily located within each of these zones around the cell site. Each of the zones and the maximum distance may be defined to be within an expected coverage area of the cell site based on the configurations of antennas at the cell site (e.g., frequency bands, output power level, etc.).

The UEs (and other devices/systems) within the zones may be continuously or periodically (e.g., based on predefined schedule) configured to obtain (e.g., determine or compute) signal attribute values based on the signals received from the cell site and the cellular connection with the cell site. For example, the UE may compute a signal attribute value as the RSRP value describing the reference signals received by the UE from the cell site. In an embodiment, the UE may obtain the signal attribute values for each respective session running at the UE. The UE may continuously or periodically (e.g., based on predefined schedule) transmit the signal attribute values (for each session) to the management system.

An application executing at the management system may evaluate the received signal attribute values based on a rule defining a threshold to determine whether to increment a clutter count associated with the respective zone in which the UE is located. The clutter count may refer to a quantity of sessions across one or more UEs in a zone that has below a threshold cellular coverage (e.g., as indicated by the signal attribute values). The rule may indicate that when the signal attribute value received from a UE located in a particular zone is greater than or equal to the threshold, a clutter count associated with the particular zone is incremented.

For example, three UEs may be located within the first zone of the cell site. A first UE may transmit a first signal attribute value for a first session and a second signal attribute value for a second session to the management system, a second UE may transmit a third signal attribute value to the management system, and a third UE may transmit a fourth signal attribute value to the management system. The application at the management system may store the received signal attribute values and compare each of the signal attribute values to a threshold defined in a rule associated with the cell site. The application may determine that the first signal attribute and second signal attribute are greater than or equal to the threshold, while the third signal attribute and fourth signal attribute are less than the threshold. The application may then increment a clutter count associated with the first zone by two (e.g., indicating that there are two more sessions in the zone having a poor cellular coverage).

The application may similarly receive the signal attribute values from all UEs in the second zone, all UEs in the third zone, and so on. The application may then determine the clutter count associated with each zone based on a comparison of the received signal value attributes in the zone to the threshold. The application may additionally or alternatively determine a percentage of poor coverage sessions in the zone based on a proportion of the clutter count to the total session count in the zone. For example, if there are one hundred total sessions in a zone and the clutter count is twenty, then percentage of poor coverage sessions in the zone is 20%.

The application may store a signal parameter for each zone, in which the signal parameter includes the clutter count or the percentage of poor coverage sessions, each of which is indicative of cellular coverage within the geographic area corresponding to the zone. The application may then generate a vector (e.g., or any other type of data structure) for the cell site including the signal parameter for each zone. The type of signal parameter may be consistent throughout the vector (e.g., the vector may include only clutter count values or only percentages for each zone, a single vector may not include both clutter count values and percentages). The vector may also include an identification (e.g., unique value) of each zone in association with the signal parameter of the zone, to map the signal parameter to the respective zone.

The application may then perform a comparison between the vector of the cell site and a baseline vector. The baseline vector may have a set of signal parameters (again, either clutter counts or percentages) that correspond to a cluttered cell site having a known clutter problem (e.g., dense foliage, tall buildings, scaffoldings, parapet walls, or other physical obstructions immediately adjacent to or proximate to the cell site). For example, the baseline vector may have a set of signal parameters based on signal attribute values received from UEs in different zones, in which the signal attribute values are based on signals received from the cluttered cell site. For example, the signal attribute values may indicate that UEs that are positioned within a zone that is 400 meters from the cell site have an RSRP value of less than −114 decibel-milliwatts (dBm) (which may be indicative of poor coverage at a close distance). The baseline vector may be based on an average of signal attribute values received from multiple devices served by the cluttered cell site, indicative of signal strength decreasing rapidly at shorter distances from the cluttered cell site. In an embodiment, the baseline vector may be generated using a machine learning model or artificial intelligence model that uses historical signal attribute values received from UEs served by cell sites positioned in a cluttered environment that affects signal strength and quality. In this way, the baseline vector may be an optimal reference by which to compare a vector of a cell site to determine whether the cell site is positioned in a cluttered environment that affects signal strength and quality.

The application may perform the aforementioned comparison using various types of vector comparison methods and algorithms. For example, the application may perform a cosine similarity between the baseline vector and the vector of the cell site to quantify a similarity (or difference) between the baseline vector and the vector of the cell site. The cosine similarity method may calculate the similarity between the baseline vector and the vector of the cell site by calculating a cosine of the angle between the baseline vector and the vector of the cell site. For example, when the baseline vector and the vector of the cell site point in the same direction, the output of the cosine similarity calculation may be closer to +1, indicating a high similarity between the baseline vector and the vector of the cell site. In contrast, when the vectors are perpendicular or point in opposite directions, the value may be closer to 0or −1, indicating low similarity or dissimilarity between the baseline vector and the vector of the cell site.

While the cosine similarity method is described herein as one example method used to compare the baseline vector and the vector of the cell site, it should be appreciated that one or more other methods of comparing vectors may be used to compare the baseline vector and the vector of the cell site to output a comparison parameter quantifying the similarity (or difference) between the baseline vector and the vector of the cell site. For example, additionally or alternatively to a cosine similarity method, a Euclidian distance method, Manhattan distance, Minkowski distance, Jaccard similarity, cosine distance, hamming distance, or other vector comparison may be used.

The application may then compare the comparison parameter (e.g., the output of the cosine similarity method) with another threshold based on a rule associated with the cell site to determine a remediation action to perform with respect to the cell site. For example, a rule may indicate that when the comparison parameter is a value that is less than the threshold (and in some cases, different from the threshold by at least a certain amount), that the cell site is not located in a cluttered environment, and thus no remediation action may need to be instructed. In contrast, a rule may indicate that when the comparison parameter is a value that is greater than or equal to the threshold, the application may instruct the performance of one or more remediation actions in an attempt to resolve the cellular coverage issues.

For example, the remediation action may be to configure the cell site to operate only on lower frequencies (e.g., sub-1 GHz), or frequencies that may travel longer distances and can penetrate obstacles like buildings and trees more effectively. Additionally or alternatively, the remediation action may be to transmit an alarm to the incident reporting system or NOC, in which the alarm includes a flag or other data indicative that an identified cell site is positioned in a cluttered environment. The NOC/incident reporting system may take additional actions as prescribed to examine and resolve the alarm. Additionally or alternatively, the remediation action may be to dispatch a technician to physically examine the cell site, potentially adjust the direction, height, or other settings of antennas at the cell site to avoid the obstructions, cut down or remove the trees/foliage around the cell site if permitted by local regulations, relocate the cell site to a different location, shut down the cell site entirely, etc.

The type of remediation action may be determined based on various factors. For example, the type of remediation action may be based on the signal attribute values received from the UEs in the zones (e.g., when there is zero cellular coverage anywhere within 100 meters of the cell site, then remediation action may be to shut down the cell site entirely). The type of remediation action may also be based on the number of UEs connected to the cell site (e.g., the remediation action may be one that has a lower customer impact when a greater quantity of devices are connected to the cell site), local regulations, the type of clutter around the cell site, etc. In an embodiment, the application may use a machine learning model or artificial intelligence model to determine a remediation action for a cell site. The machine learning model or artificial intelligence model may be trained based on successful remediation actions taken for cell sites that have previously been associated with similar signal attribute values.

In this way, the embodiments disclosed herein serve to improve the performance of NEs (e.g., cell sites, cell towers, base stations, repeaters, antennas, radio heads, etc.) by intelligently evaluating data received from UEs served by the NEs. To this end, the embodiments disclosed herein have a relatively light footprint because the computations (e.g., vector computations, cosine similarity computations) are all performed at the management system over the network, in which the management system may be separate from or part of the core network. Moreover, by automating the process of identifying NEs located in cluttered environments and implementing remediation actions to address the coverage at these cluttered cell sites, UEs may experience a better cellular connection with stronger signal strength and quality at relatively close distances from the NE. Therefore, in general, the embodiments disclosed herein also serve to increase network capacity by decreasing call/connection drops caused by signal degradation from cluttered cell sites.

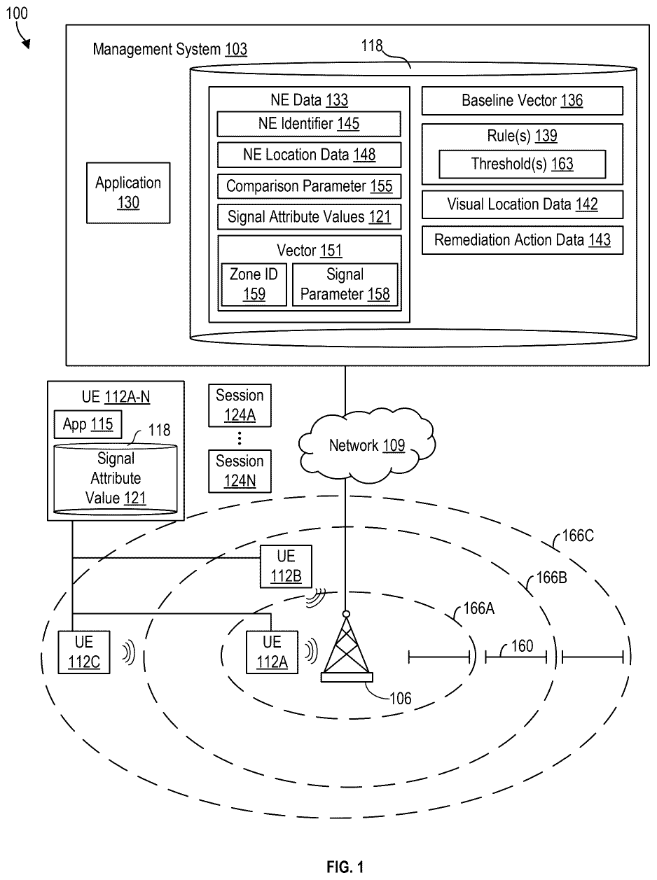

Turning now to FIG. 1, a communication network 100 is described. The communication network 100 includes a management system 103, a cell site 106, a network 109, and multiple UEs 112A-N served by the cell site 106. The network 109 may be one or more private networks, one or more public networks, or a combination thereof. While the management system 103 is shown as separate from the network 109, it should be appreciated that the management system 103 may be included as part of the network 109.

The communication network 100 may include a core network and a radio access network (RAN) communicatively coupled to the management system. The core network may be the central telecommunications infrastructure for managing and routing data, voice, and signaling traffic between various access networks, service platforms, and UEs 112A-N. The RAN is a telecommunications network that connects access networks, service platforms, and UEs 112A-N to the core network via radio waves. The RAN may include the cell site 106, base stations, antennas, and other network elements (NE) (e.g., routers, switches, bridges, virtual networks, etc.) that manage the transmission and reception of wireless signals.

The cell site 106 refers to a physical location equipped with antennas and other radio equipment that enables wireless communication between UEs 112A-N and the network 109, RAN, and/or core network. The cell site 106 transmits and receives radio signals, providing cellular coverage to a coverage area (e.g., a geographic area around the cell site 106), and connects to the core network through the RAN.

The UEs 112A-N may refer to any device that connects to the network 109 via the cell site 106 to access services and communicate with the core network via the RAN. Examples of UEs 112A-N may include smartphones, tablets, laptops, Internet of Things (IoT) devices and wearable devices.

As shown in FIG. 1, exemplary UEs 112A, 112B, and 112C are positioned at difference distances from the cell site 106 and within a coverage area of the cell site 106. The coverage area of the cell site 106 may refer to the geographic region in which the radio signals from the cell site 106 can be received by the UEs 112A-C with sufficient strength to provide reliable communication services (e.g., voice calls, text messaging, and data connectivity) to the UEs 112A-C. The coverage area of the cell site 106 may extend up to several miles in urban environments and even farther in rural areas.

The embodiments disclosed herein may logically divide at least a portion coverage area of the cell site 106 into successive zones 166A-C (e.g., regions within the coverage area) based on a rule 139. For example, a rule 139 may indicate an incremental distance 160 for each of the successive zones 166A-C and a maximum distance. The zones 166A-C may then be defined based on the incremental distance 160 until the maximum distance is reached.

For example, suppose the incremental distance 160 is 100 meters and the maximum distance is 1 mile. The first zone 166A (closest to the cell site 106) may extend from the cell site 106 radially (and in some cases, three dimensionally) away from the cell site 106 for the incremental distance 160 of 100 meters, thereby creating a geographic region of 100 meters around the cell site 106 as the zone 166B. The next zone 166B may extend from an edge of the zone 166A radially outward for the incremental distance 160, thereby creating another geographic region of 100 meters around the first zone 166A as the zone 166B. The third zone 166C may extend from an edge of the zone 166B radially outward for the incremental distance 160, thereby creating another geographic region of 100 meters around the first zone 166B as the zone 166C.

This process may continue until multiple zones 166A-C are defined between the cell site 106 and the maximum distance of 1 mile. While only three zones 166A-C are shown in FIG. 1, it should be appreciated that there may be any number of zones 166A-C around a cell site 106 and within a coverage area of the cell site 106. Similarly, while only three UEs 112A-C are shown as being positioned in the zones 166A-C, it should be appreciated that there may be any number of UEs 112A-N in each of the zones 166A-C.

Referring back to the components of the individual UEs 112A-N, each UE 112A-N may include an application 115 stored in a memory of the UE 112A-N, which may be executed by a processor of the UE 112A-N to perform the methods of physical network environment evaluation described herein. Each UE 112A-N may be running one or more sessions 124A-N at one time. A session 124A-N refers to an active communication or data exchange established between the UE 112A-N and the network 109, allowing the user to access various types of services. For example, a session 124A-N may include voice calls, video streaming, web browsing, and/or file downloads over the network 109.

The UE 112A-N may also include a data store 118 (e.g., one or more memories). The data store 118 may store signal attribute values 121 (which are computed by the application 115 and then stored in the data store 118). The signal attribute values 121 may be values representing a cellular signal strength and signal quality from a particular cell site 106, for each session 124A-N. The signal attribute value 121 may be used to determine a quality of a connection between a UE 112A-N and the cell site 106. For example, the signal attribute value 121 may refer to the reference signal received power (RSRP), which may be a value measuring an average power received via one or more reference signals from a single cell site 106 for a session 124A-N. The RSRP value may be used by the core network to, for example, make decisions about handovers, cell selection, and resource allocation. Other examples of signal attribute values 121 indicative of a cellular strength and quality from the cell site 106 may include a reference signal received quality (RSRQ) value (e.g., a value measuring a quality of reference signals received from the cell site 106, combining RSRP and overall signal interference), signal-to-noise (SNR) ratio (e.g., a ratio of signal power received from the cell site 106 to background noise), receive signal strength indicator (RSSI) (e.g., a value measuring the total received power from the cell site 106, including signals and interference), channel quality indicator (CQI) (e.g., a value indicating how well the UE 112A-N can support specific data rates based on channel conditions), etc. As described herein, the application 115 may compute and transmit the signal attribute values 121 to the management system 103 (e.g., either continuously or periodically based on a predefined schedule).

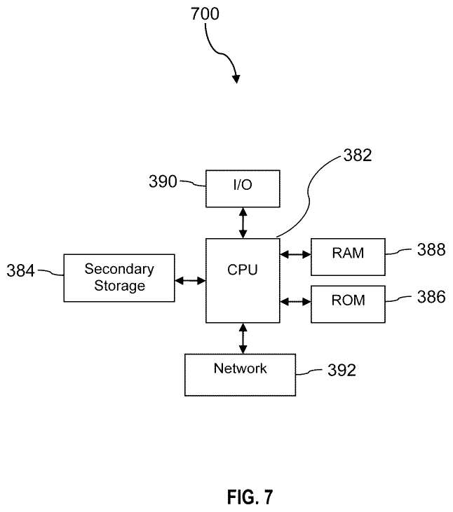

The management system 103 may be a computer system (e.g., the computer system of FIG. 7 described below), including processing, memory, and communication resources to support the methods of physical network environment evaluation described herein. The management system 103 may be a standalone system (e.g., set of servers across one or more data centers) or may be a system internal to the core network of an MNO. The management system 103 includes an application 130 stored in a memory of the management system 103, which may be executed by a processor of the management system 103 to perform the methods of physical network environment evaluation described herein.

The management system 103 also includes a data store 118 (e.g., one or more memories) storing data that may be used to perform the methods of physical network environment evaluation described herein. As shown in FIG. 1, the data store 118 may store NE data 133, a baseline vector 136, one or more rules 139, visual location data 142, and remediation action data 143 (among other types of data). The NE data 133 may include data describing all of the NEs (e.g., repeaters, small cell devices, routers, switches, bridges, virtual networks, links, etc.), cell sites 106, and components (e.g., antennas, radio heads, and other radio components) at each of the cell sites 106. The NE data 133 may include an NE identifier 145, NE location data 148, signal attribute values 121, a comparison parameter 155, and a vector 151. The NE identifier 145 may be an identifier uniquely identifying the NE being described in the NE data 133 (e.g., an identifier of the cell site 106). The NE location data 148 may include a location (e.g., in the form of Global Positioning System (GPS) coordinates or a geohash value) of the NE being described in the NE data 133 (e.g., a location of the cell site 106). The signal attribute values 121 are the signal attribute values 121 received from the NE being described in the NE data 133 (e.g., the signal attribute values 121 received from the UEs 112A-N describing a connection of the UEs 112A-N to the cell site 106).

The vector 151 may be a data structure including conditional signal parameters 158 for each zone 166A-C away from the NE being described in the NE data 133. As described above, each cell site 106 may be associated with one or more zones 166A-C, and the UEs 112A-C within each of the zones 166A-C may transmit the signal attribute values 121 to the management system 103. The application 130 may aggregate the signal attribute values 121 received from the UEs 112A-C in each zone 166A-C to compute a signal parameter 158 indicating a strength and quality of a connection of the UEs 112A-N in the zone 166A-C to the cell site 106 based on a rule 139.

For example, the rule 139 may indicate that when the signal attribute value 121 (or an absolute value of the signal attribute value 121) is greater than a threshold 163, the application 130 may use the signal attribute value 121 to compute the signal parameter 158 of the zone 166A-C. For example, the application 130 may receive the signal attribute value 121 from the UE 112A in zone 166A and compare the signal attribute value 121 to the threshold 163 in the rule 139. When the signal attribute value 121 (or an absolute value of the signal attribute value 121) is greater than the threshold 163, the application 130 may either increment a clutter count defining a quantity of signal attribute values 121 received from the zone 166A that exceed the threshold 163, or compute a percentage of poor coverage sessions based on the quantity of signal attribute values 121 received from the zone 166A that exceed the threshold 163 and the total quantity of signal attribute values 121 received from the zone 166A. In an embodiment, the signal parameter 158 may refer to either the clutter count of the zone 166A-C or the percentage of poor coverage sessions in the zone 166A-C. In some cases, the vector 151 may include a zone identifier 159 (e.g., a value uniquely identifying a zone 166A-C), in which the zone identifier 159 maps the signal parameter 158 of the respective zone 166.

For example, suppose there are five zones 166A-C defined for the cell site 106, and the signal parameter 158 (e.g., clutter count) of each zone is as follows {[zone 1, clutter count of 5], [zone 2, clutter count of 10], [zone 3, clutter count of 15], [zone 4, clutter count of 20], [zone 5, clutter count of 25]}. In this case, the vector 151 for the cell site 106 may include the values {5, 10, 15, 20, and 25}, indicating the clutter count or quantity of sessions 124 with poor coverage in each of the five zones 166A-C. For example, a rule 139 may define poor coverage as a session 124 having an absolute value of an RSRP value of greater than 114 dBm, such that only sessions 124 having an absolute value of an RSRP value of greater than 114 dBm are included in the clutter count for a zone 166.

The comparison parameter 155 may be the value obtained based on a comparison between the vector 151 for an NE and a baseline vector 136 for a similar type of NE. For example, the comparison parameter 155 may be a value computed based on performing a cosine similarity between the vector 151 of the cell site 106 and the baseline vector 136 of the cell site 106. The baseline vector 136 may have a set of signal parameters (again, either clutter counts or percentages) that correspond to a cluttered cell site having a known clutter problem (e.g., dense foliage, tall buildings, scaffoldings, parapet walls, or other physical obstructions immediately adjacent to or proximate to the cell site). For example, the baseline vector 136 may have a set of signal parameters based on signal attribute values 121 received from UEs 112A-N in different zones from the cluttered cell site having the known clutter problem. For example, the signal attribute values 121 may indicate, for example, that UEs 112A-N that are positioned within a zone that are located 400 meters from the cell site have an RSRP value of less than −114 decibel-milliwatts (dBm) (which may be indicative of poor coverage at a close distance). The baseline vector 136 may be based on an average of signal attribute values 121 received from multiple UEs 112A-N served by the cluttered cell site, in which the signal attribute values 121 indicate a rapidly decreasing signal strength at shorter distances from the cluttered cell site. In an embodiment, the baseline vector 136 may be generated using a machine learning model or artificial intelligence model that uses historical signal attribute values received from UEs 112A-N served by cell sites positioned in a cluttered environment that affects signal strength and quality. In this way, the baseline vector 136 may be an optimal reference by which to compare a vector 151 of a cell site 106 to determine whether the cell site 106 is positioned in a cluttered environment that affects signal strength and quality.

The rules 139 may be logic or code programmed at the application 130 to perform certain tasks and/or processes based on one or more conditions or events. For example, the rules 139 may instruct the application 130 to perform predefined tasks and/or processes based on whether a signal attribute value 121 meets a first predefined threshold 163 and/or on based on whether a comparison parameter 155 meets a second predefined threshold 163.

The visual location data 142 may refer to data that may be used to present visual data representative of the cellular coverage at the zones 166A-C around the cell site 106 and within the cell site 106. For example, the visual location data 142 may store data for respective hexbins, which are hexagon shaped grid points used in data visualization to aggregate and display spatial data. Each zone 166A-C may be divided into multiple hexagonal cells or hexbins, in which each hexbin contains averaged or aggregated data points representative of the signal attribute values 121 received from UEs 112A-N in the geographic area represented by the hexbin. For example, a hexbin representing a geographic area may be displayed with a certain visual attribute (e.g., color, shading, gradient, pattern, etc.) to represent a signal attribute value 121 of the UEs 112A-N and/or sessions 124A-N located within the geographic area represented by the hexbin. By visually representing the signal attribute values 121 throughout the coverage area of the cell site 106 as hexbins, patterns of signal coverage across the zones 166A-C become clearer.

The visual location data 142 may be presented to an operator or analyst (in a display of the management system 103 or a display of another device communicatively coupled to the management system 103) in the form of a map with hexbins positioned throughout each of the zones 166A-C. The visual attribute of each of the hexbins in each of the zones 166A-C allows the operator or analyst to easily identify coverage gaps, areas of weak signals, or zones of strong connectivity, to provide an intuitive representation of cellular performance across different parts of the coverage area.

The remediation action data 143 may be a collection of remediation actions taken in response to a detection of a cluttered cell site 106, and an indication of whether the remediation action successfully resolved the cellular coverage issues at the cell site 106, or whether the cell site 106 had to ultimately be shut down to save on resources and costs. Over time, the remediation action data 143 may collect a repository of valuable data indicative of successful remediation actions, which may be used to train a machine learning model or an artificial intelligence model to predict more optimal remediation actions in the future.

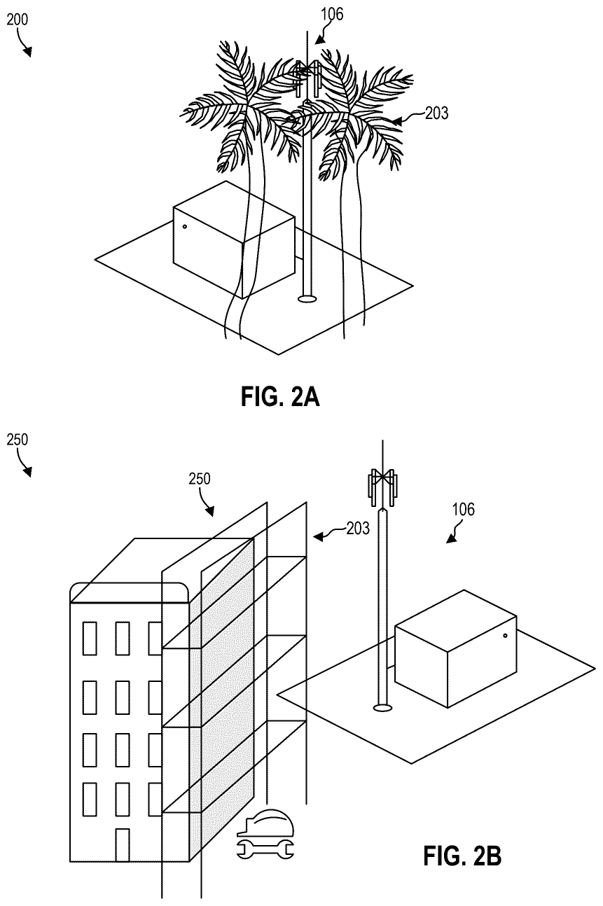

Referring now to FIGS. 2A and 2B, shown are diagrams illustrating a cluttered environment around a cell site 106. As mentioned above, the cell site 106 is a physical location equipped with antennas and other radio equipment enabling wireless communication between UEs 112A-N (hereinafter referred to as “UEs 112”) and a mobile network (including network 109, the RAN, the core network, etc.). For example, as shown in FIGS. 2A-B, the cell site 106 may include a cell tower (e.g., a physical structure or mast that holds the antennas and radio heads) and a shelter housing power supplies and signal processing equipment.

FIG. 2A illustrates a cell site 106 surrounded by clutter 203 in the form of tall trees, or more specifically, the dense foliage of the trees positioned proximate to (e.g., or within a predefined distance from) the antennas/radio heads on the cell site 106. When dense foliage is positioned close to or even touching the antennas on the cell site 106, the foliage can significantly block and absorb radio signals emitted from the antennas, leading to several negative effects on cellular coverage. For example, the leaves can act as a physical barrier, scattering and attenuating radio signals that pass through or around the trees, weakening the strength and quality of the radio signals transmitted from the antennas on the cell site 106.

The close proximity of the clutter 203 (i.e., the trees) may significantly degrade or even block radio signals at close distances from the cell site 106 (e.g., less than 500 meters from the cell site 106). Additionally, these signals that have passed through the clutter 203 may become less reliable and prone to interference, leading to slower data speeds, dropped calls, and poor connectivity for UEs 112 in the zones 166A-C.

For this reason, the signal attribute values 121 for sessions 124A-N (sometimes referred to hereinafter as “sessions 124”) of UEs 112 connected to the cell site 106 may rapidly degrade across zones 166A-C (sometimes hereinafter referred to as “zones 166”) as the zones 166A-C increase in distance from the cluttered cell site 106. The signal attribute values 121 received from UEs 112 served by a cluttered cell site 106 may be significantly different from the signal attribute values 121 received from UEs 112 connected to standard cell sites 106 that are not surrounded by clutter 203. Said another way, the signal attribute values 121 for sessions 124A-N of UEs 112 connected to cell sites 106 that are not surrounded by clutter 203 may not rapidly degrade at zones 166 proximate to the cell site 106 (e.g., less than 500 meters from the cell site 106), but instead may remain high at zones 166 proximate to the cell site 106, and steadily degrade at a low rate with increasing distances from the cell site 106. Meanwhile, the signal attribute values 121 for sessions 124A-N of UEs 112 connected to cluttered cell sites 106 may rapidly degrade or be low at zones 166 proximate to the cell site 106.

FIG. 2B illustrates a cell site 106 surrounded by clutter 203 in the form of structural materials (e.g., buildings, construction sites, scaffolding, parapet walls, and/or other structural materials) positioned proximate to (e.g., or within a predefined distance from) the antennas/radio heads on the cell site 106. For example, the structural material may include certain types of materials that cause significant obstruction to radio signals, such as metal (e.g., reflects and absorbs radio waves), dense concrete and brick, certain types of glass and wood. The structural materials may impact cellular coverage and performance of the cell site 106.

When the structural materials are positioned close to the antennas on the cell site 106, the structural materials can significantly block and absorb radio signals, leading to several negative effects on cellular coverage. The structural materials can block or reflect the radio signals transmitted by the cell site 106, reducing the strength of the signals while causing interference. For example, metal scaffolding and parapet walls can absorb or reflect radio waves, leading to signal attenuation and/or multi-path interference.

The close proximity of the clutter 203 (i.e., the structural material) may significantly degrade or even block radio signals at close distances from the cell site 106 (e.g., less than 500 meters from the cell site 106). As described above, the signal attribute values 121 for sessions 124 of UEs 112 connected to the cell site 106 affected by clutter 203 may rapidly degrade across zones 166 when compared to the signal attribute values 121 for sessions 124A-N of UEs 112 connected to cell sites 106 that are not affected by clutter 203.

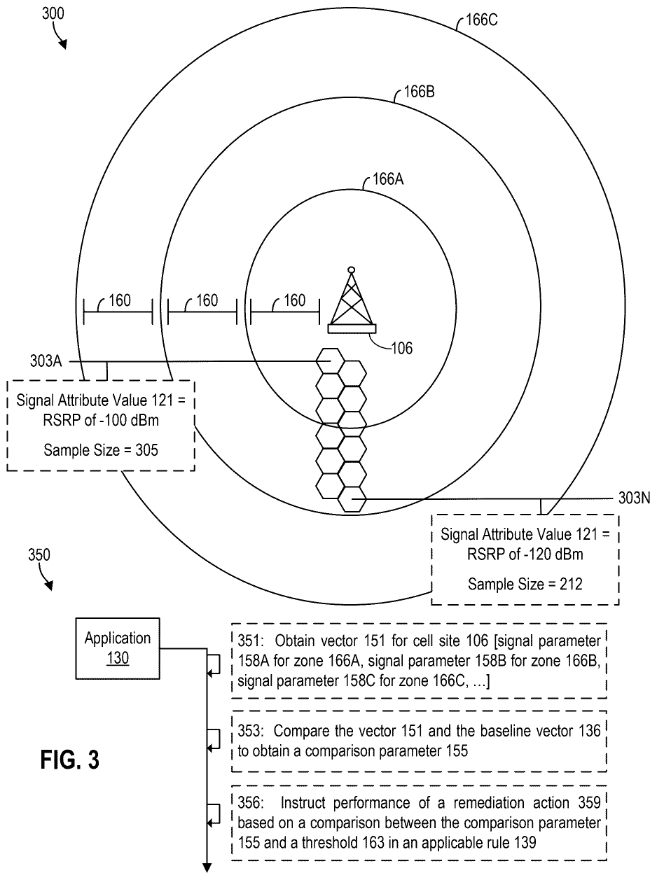

Turning now to FIG. 3, shown is a diagram 300 illustrating the zones 166A-C around a cell site 106 and a method 350 of evaluating the environment around the cell site 106 according to various embodiments of the disclosure. In an embodiment, the application 130 at the management system 103 may logically divide a portion of a coverage area of a cell site 106 into successive zones 166A-C based on a rule 139. One or more rules 139 may indicate that different types of cell sites 106 or different cell site locations (e.g., region/city/state) may have different incremental distances 160 for the zones 166A-C and/or may have a different maximum distance for the zones 166A-C. For example, the rule 139 may indicate that cell sites 106 within rural areas may have a first predefined incremental distance 160 for the zones 166A-C, while cell sites 106 in urban areas have a second predefined incremental distance 160 for zones 166A-C. The first incremental distance 160 may be greater than the second incremental distance 160 because urban areas may benefit from a more fine-grained analysis of smaller zones 166A-C around the cell site 106.

In this way, the application 130 may use the coverage area and known location of the cell site 106 to measure and define the zones 166A-C around the cell site 106 based on the incremental distance 160 indicated in a relevant rule 139. The coverage area (e.g., in the form of GPS coordinate ranges or geohash values) and known location of the cell site 106 may be predetermined and stored at the data store 118 of the management system 103. For example, the application 130 may define the zone 166A around the cell site 106 having the incremental distance 160 from the cell site 106, then define the zone 166B from the outer edge of the zone 166A and radially outward for the incremental distance 160, then define the zone 166C from the outer edge of the zone 166B and radially outward for the incremental distance 160, and so on until all zones 166A-C are defined until the maximum distance.

While the zones 166A-C shown in FIG. 3 are shown as circular and omnidirectional around the cell site 106, it should be appreciated that the zones 166A-C need not necessarily be circular and omnidirectional. Instead, the zones 166A-C may be directional (e.g., angled to a particular geographic region), and/or may be shaped in any other form (e.g., rectangle, square, triangle, semi-circle, etc.).

The diagram 300, which includes the cell site 106, the boundaries of the zones 166A-C, and hexbins 303A-N, may be presented on a display (either at the management system 103 or at another device communicatively coupled to the management system 103). While only a few hexbins 303A-N are illustrated in FIG. 3, it should be appreciated that each of the zones 166A-C may be filled with hexbins 303A-N. In an embodiment, the visual location data 142 may include the data used to present the diagram 300 with the zones 166A-C and the hexbins 303A-N on a display.

Each of the zones 166A-C may include a hexagon-shaped grid with individual hexbins 303A-N representing respective geographic areas within the zones 166A-C. Specifically, each of the hexbins 303A-N may be presented with a visual attribute (e.g., color, shading, gradient, pattern, etc.) to represent an average signal attribute value 121 received from the UEs 112A-N based on different sessions 124A-N located within the geographic area represented by the hexbin. For example, hexbin 303A in zone 166A (relatively close to the cell site 106) includes a sample size of 305 and an RSRP value of −100 dBm (e.g., an average signal attribute value 121). The sample size of 305 may refer to a quantity of sessions 124 and/or a quantity of signal attribute values 121 received from UEs 112 in the geographic area represented by the hexbin 303A, and the RSRP value of −100 dBm may be an average of all of the RSRP values received based on the 305 sessions 124 across the UEs 112. The RSRP value of −100 dBm at such a close distance from the cell site 106 may be indicative of clutter 203 around the cell site 106. Nevertheless, the area around the cell site 106 at increasing distances may continue to be similarly evaluated to detect a pattern of low or decreasing signal strength from the cell site 106 that indicates a likelihood that the cell site 106 is surrounded by clutter 203.

To this end, hexbin 303N in zone 166B (farther from the cell site 106 than hexbin 303A, but still relatively close to the cell site 106) includes a sample size of 212 and an RSRP value of −120 dBm (e.g., an average signal attribute value 121). The sample size of 212 may refer to a quantity of sessions 124 and/or a quantity of signal attribute values 121 received from UEs 112 in the geographic area represented by the hexbin 303B, and the RSRP value of −120 dBm may be an average of all of the RSRP values received based on the 212 sessions 124 across the UEs 112. The RSRP value of −120 dBm at such a close distance from the cell site 106 may further corroborate the determination that clutter 203 may be present within a predefined distance from cell site 106.

In an embodiment, the diagram 300 may be presented on the display with a user interface, in which the user may interact with (e.g., select or hover a pointer over) a hexbin 303A-N to display a pop-up window with the average signal attribute value 121 and sample sizes, as mentioned above. In this way, an operator or analyst may easily identify coverage gaps, areas of weak signals, or zones of strong connectivity by viewing the diagram 300 because the diagram 300 provides an intuitive representation of cellular performance across the zones 166A-C. In some cases, the diagram 300 by itself may be indicative of clutter 203 around the cell site 106, based on an analysis of the visual attributes of the hexbins 303A-N.

Referring now to method 350 shown in FIG. 3, which is performed by the application 130 executed at the management system 103, and may be performed based on evaluation of the zones 166A-C and corresponding signal attribute values 121 received from UEs 112 in the zones 166A-C. Method 350 may begin with operation 351, in which the application 130 obtains (e.g., generates or computes) a vector 151 for the cell site 106. The vector 151 may include a signal parameter 158A for zone 166A, a signal parameter 158B for zone 166B, a signal parameter 158C for zone 166C, and so on for each zone 166A-C. The signal parameter 158A-C may refer to either the clutter count of the zone 166A-C or the percentage of poor coverage sessions in the zone 166A-C, as described above.

In an embodiment, the application 130 may then proceed to operation 353 to compare the vector 151 of the cell site 106 and a baseline vector 136 indicative of a cell site 106 known to be surrounded by clutter 203 to obtain a comparison parameter 155. For example, the application 130 may perform a cosine similarity method between and the vector 151 of the cell site 106 and the baseline vector 136 to quantify a similarity (or difference) between the baseline vector 136 and the vector 151 of the cell site 106 as the comparison parameter 155. The cosine similarity method may normalize the data in the vector 151 of the cell site 106, and compare the vector 151 with the normalized data in the baseline vector 136 to calculate the similarity between the baseline vector 136 and the vector 151 of the cell site 106. The method may involve calculating a cosine of the angle between the baseline vector 136 and the vector 151 of the cell site 106 to obtain the comparison parameter 155, which is a value indicative of the similarity or difference between the baseline vector 136 and the vector 151 of the cell site 106.

For example, when the baseline vector 136 and the vector 151 of the cell site 106 point in the same direction, the comparison parameter 155 output by the cosine similarity method may be closer to +1, indicating a high similarity between the baseline vector 136 and the vector 151 of the cell site 106. In contrast, when the baseline vector 136 and the vector 151 of the cell site 106 are perpendicular or point in opposite directions, the comparison parameter 155 may be closer to 0or −1, indicating low similarity or dissimilarity between the baseline vector 136 and the vector 151 of the cell site 106.

While the cosine similarity method is described herein as one example method used to compare the baseline vector 136 and the vector 151 of the cell site 106 to obtain a comparison parameter 155, it should be appreciated that one or more other methods of comparing vectors may be used to compare the baseline vector 136 and the vector 151 of the cell site 106 to output the comparison parameter 155 quantifying the similarity (or difference) between the baseline vector 136 and the vector 151 of the cell site. For example, additionally or alternatively to a cosine similarity method, a Euclidean distance method, Manhattan distance, Minkowski distance, Jaccard similarity, cosine distance, hamming distance, or other vector comparison may be used.

The application 130 may then proceed to operation 356 to instruct performance of a remediation action 359 based on a comparison between the comparison parameter 155 and a threshold 163 identified in an applicable rule 139. For example, the rule 139 may indicate that certain types of remediation actions 359 are to be performed (or not be performed) when the comparison parameter 155 meets or exceeds a predefined threshold 163 (or in some cases, is less than a predefined threshold 163). Each rule 139 may be applicable only to, for example, certain types of cell sites 106 and/or certain predefined location/regions in which the cell sites 106 are located.

For example, a rule 139 may indicate that when the comparison parameter 155 is a value that is less than the threshold 163 (and in some cases, different from the threshold 163 by at least a certain amount), that the cell site 106 is not located in a cluttered environment, and thus no remediation action 359 may need to be instructed. In contrast, a rule 139 may indicate that when the comparison parameter 155 is a value that is greater than or equal to the threshold 163, the application 130 may instruct the performance of one or more remediation actions 359 in an attempt to resolve the cellular coverage issues. Details of the remediation actions 359 and the success/failure of the remediation actions 359 may be stored in the remediation action data 143.

For example, the remediation action 359 may be to configure the cell site 106 to operate only on lower frequencies (e.g., sub-1 GHz), or frequencies that may travel longer distances and can penetrate obstacles like buildings and trees more effectively (i.e., frequencies that can penetrate through clutter 203). Additionally or alternatively, the remediation action 359 may be to transmit an alarm to an incident reporting system or NOC, in which the alarm includes a flag or other data indicative that an identified cell site 106 is positioned in a cluttered environment. Additionally or alternatively, the remediation action 359 may be to dispatch a technician to physically examine the cell site 106, potentially adjust the direction, height, or other settings of antennas at the cell site 106 to avoid the obstructions, cut down or remove the trees/foliage around the cell site 106 if permitted by local regulations, relocate the cell site 106 to a different location, shut down the cell site 106 entirely, etc.

The type of remediation action 359 may be determined based on various factors and the remediation action data 143 indicative of prior successful remediation actions 359 for different types of NEs or cell sites 106. For example, the type of remediation action 359 may be based on the signal attribute values 121 received from the UEs 112 in the zones 166 (e.g., when there is zero cellular coverage within 100 meters of the cell site 106, then remediation action 359 may be to shut down the cell site 106 entirely). The type of remediation action 359 may also be based on the number of UEs 112 connected to the cell site 106 (e.g., the remediation action 359 may be one that has a lower customer impact), local regulations, the type of clutter around the cell site, etc. In an embodiment, the application 130 may use a machine learning model or artificial intelligence model to determine a remediation action 359 for a cell site 106. The machine learning model or artificial intelligence model may be trained based on the remediation action data 143 describing successful remediation actions 359 taken for cell sites 106 associated with similar signal attribute values 121.

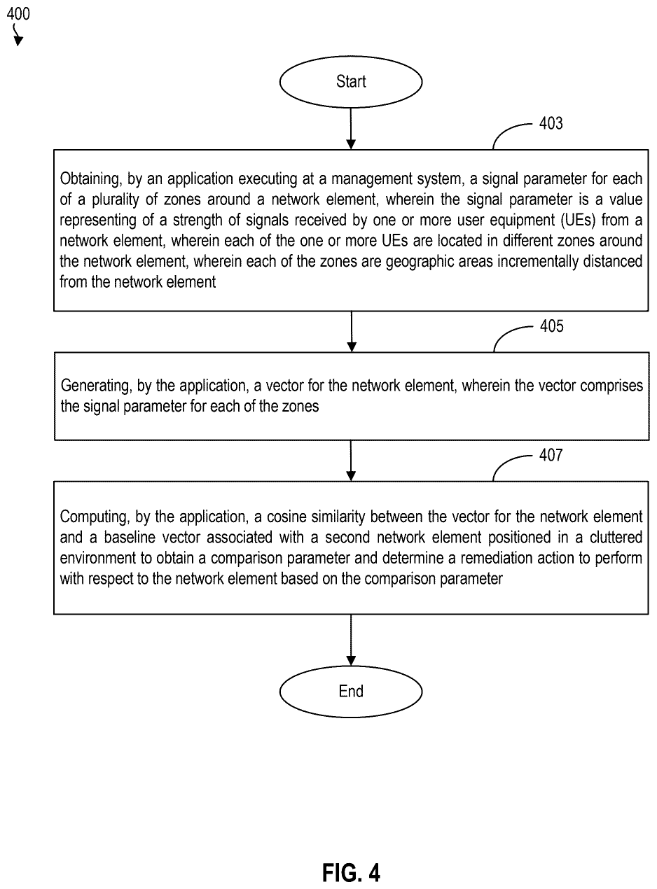

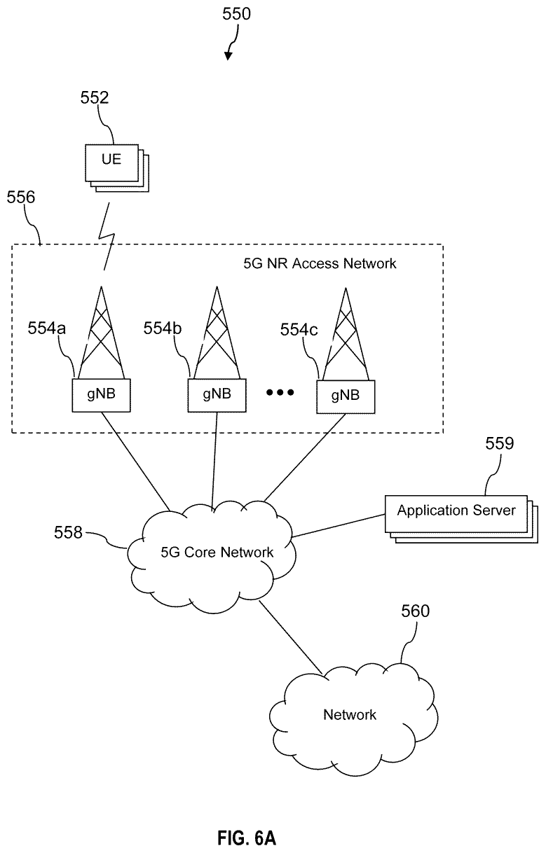

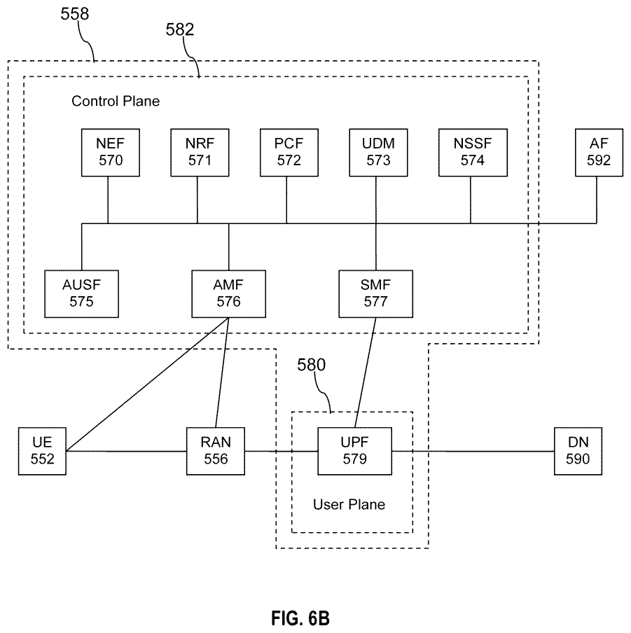

Referring now to FIG. 4, shown is a method 400 of physical network environment evaluation in the communication network 100 of FIG. 1 according to various embodiments of the disclosure. Method 400 may be implemented by the application 130 at the management system 103. In embodiments, the method 400 may be implemented using a computer system with components as shown in FIG. 6. As illustrated, method 400 of FIG. 4 includes a number of enumerated operations, but embodiments of the operations in FIG. 4 may include additional operations before, after, and in between the enumerated operations. In some embodiments, one or more of the enumerated operations may be omitted or performed in a different order.

At step 403, method 400 comprises obtaining, by an application 130 executing a management system 103, a signal parameter 158 for each of a plurality of zones 166 around a network element (e.g., the cell site 106). In an embodiment, the signal parameter 158 is a value representing of a strength of signals received by one or more UEs 112 from a network element. The one or more UEs 112 may be located in different zones 166 around the network element, and each of the zones 166 are geographic areas incrementally distanced from the network element. At step 405, method 400 comprises generating, by the application 130, a vector 151 for the network element. The vector 151 comprises the signal parameter 158 for each of the zones 166. At step 407, method 400 comprises computing, by the application, a cosine similarity between the vector 151 for the network element and a baseline vector 136 associated with a second network element positioned in a cluttered environment to obtain a comparison parameter 155 and determine a remediation action 359 to perform with respect to the network element based on the comparison parameter 155.

Method 400 may include other steps and/or features that are not otherwise shown in FIG. 4. In an embodiment, the baseline vector 136 comprises values representative of the second network element experiencing signal degradation due to being positioned in the cluttered environment. In an embodiment, each signal parameter 158 for each zone 166 is an average RSRP value across a plurality of sessions 124 running at each of the one or more UEs 112 in each zone 166. In an embodiment, the signal parameter 158 comprises a quantity of sessions 124 across running at each of the one or more UEs 112 in each zone 166 that has a signal attribute value 121 meeting a first predefined threshold 163 and/or the signal parameter 158 comprises a percentage of sessions 124 running at each of the one or more UEs 112 in each zone 166 that has a signal attribute value 121 meeting a second predefined threshold 163. In an embodiment, the comparison parameter 155 indicates a level of similarity between the vector 151 for the network element and the baseline vector 136. In an embodiment, the remediation action 359 comprises at least one of transmitting an alarm to an alarm reporting system in the communication network 100, transmitting an instruction to a technician to physically examine the network element, transmitting an instruction to a technician to modify the cluttered environment to remove obstacles around the network element, or transmitting an instruction to a technician to modify an arrangement of components at the network element.

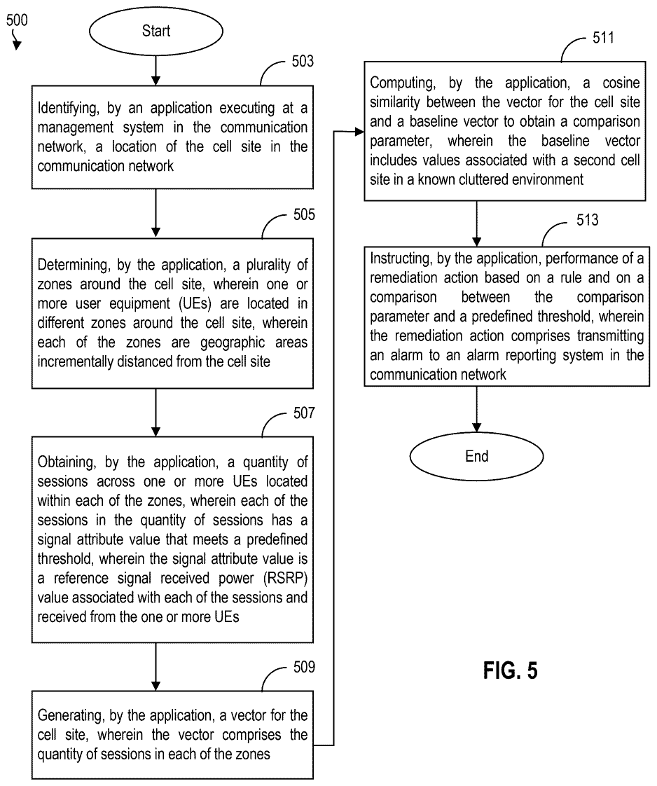

Referring now to FIG. 5, shown is a method 500 of physical network environment evaluation in the communication network 100 of FIG. 1 according to various embodiments of the disclosure. Method 500 may be implemented by the application 130 at the management system 103. In embodiments, the method 500 may be implemented using a computer system with components as shown in FIG. 6. As illustrated, method 500 of FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At step 503, method 500 comprises identifying, by an application 130 executing at a management system in the communication network, a location of the cell site in the communication network. At step 505, method 500 comprises determining, by the application 130, a plurality of zones 166 around the cell site 106. The one or more UE are located in different zones 166 around the cell site 106, and each of the zones 166 are geographic areas incrementally distanced from the cell site 106.

At step 507, method 500 comprises obtaining, by the application 130, a quantity of sessions 124 across one or more UEs 112 located within each of the zones 166. Each of the sessions 124 in the quantity of sessions 124 has a signal attribute value 121 that meets a predefined threshold 163. The signal attribute value 121 is a RSRP value associated with each of the sessions 124 and received from the one or more UEs 112. At step 509, method 500 comprises generating, by the application 130, a vector 151 for the cell site 106, in which the vector 151 comprises the quantity of sessions 124 in each of the zones 166.

At step 511, method 500 comprises computing, by the application 130, a cosine similarity between the vector 151 for the cell site 106 and a baseline vector 136 to obtain a comparison parameter 155. The baseline vector 136 includes values associated with a second cell site 106 in a known cluttered environment. At step 513, method 500 comprises instructing, by the application 130, performance of a remediation action 359 based on a rule 139 and on a comparison between the comparison parameter 155 and a predefined threshold 163. The remediation action 359 comprises transmitting an alarm to an alarm reporting system in the communication network 100.

Method 500 may include other steps and/or features that are not otherwise shown in FIG. 5. In an embodiment, the RSRP value represents an average power level of reference signals received by the one or more UEs 112 from the cell site 106, and the method 500 may further comprise receiving, by the application 130, the RSRP value from each of the one or more UEs 112 for each of the sessions 124 running at the one or more UEs 112. In an embodiment, method 500 may further comprise determining, by the application 130, that the cell site 106 is in the cluttered environment when the comparison parameter 155 meets or exceeds the predefined threshold 163.

In an embodiment, the rule 139 indicates that when the comparison parameter 155 exceeds the predefined threshold 153, the application is to further instruct a technician to physically examine the cell site 106 and modify the cluttered environment to remove obstacles around the cell site 106 or modify an arrangement of components at the cell site 106. In an embodiment, each of the zones 166 are geographic areas incrementally distanced from the cell site 106 according to an incremental distance of 100 meters.

In an embodiment, method 500 may further comprise presenting, by the application 130, on a display of the management system, a visual representation of the quantity of sessions 124 in each of the zones having the signal attribute value 121 that meets the predefined threshold 163. The visual representation comprises a plurality of hexbins 303A-N overlaying a geographic area corresponding to each of the zones from the cell site. Each of the hexbins 303A-N displays a visual representation of an average of RSRP values for each session running within the geographic area represented by a respective hexbin.

Turning now to FIG. 6A, an exemplary communication system 550 is described. In an embodiment, the communication system 550 may be implemented in the network 100 of FIG. 1. The communication system 550 includes a number of access nodes 554 that are configured to provide coverage in which UEs 552, such as cell phones, tablet computers, machine-type-communication devices, tracking devices, embedded wireless modules, and/or other wirelessly equipped communication devices (whether or not user operated), or devices can operate. The access nodes 554 may be said to establish an access network 556. The access network 556 may be referred to as RAN in some contexts. In a 5G technology generation an access node 554 may be referred to as a gigabit Node B (gNB). In 4G technology (e.g., LTE technology) an access node 554 may be referred to as an eNB. In 3G technology (e.g., CDMA and GSM) an access node 554 may be referred to as a base transceiver station (BTS) combined with a base station controller (BSC). In some contexts, the access node 554 may be referred to as a cell site or a cell tower. In some implementations, a picocell may provide some of the functionality of an access node 554, albeit with a constrained coverage area. Each of these different embodiments of an access node 554 may be considered to provide roughly similar functions in the different technology generations.

In an embodiment, the access network 556 comprises a first access node 554a, a second access node 554b, and a third access node 554c. It is understood that the access network 556 may include any number of access nodes 554. Further, each access node 554 could be coupled with a core network 558 that provides connectivity with various application servers 559 and/or a network 560. In an embodiment, at least some of the application servers 559 may be located close to the network edge (e.g., geographically close to the UE 552 and the end user) to deliver so-called “edge computing.” The network 560 may be one or more private networks, one or more public networks, or a combination thereof. The network 560 may comprise the public switched telephone network (PSTN). The network 560 may comprise the Internet. With this arrangement, a UE 552 within coverage of the access network 556 could engage in air-interface communication with an access node 554 and could thereby communicate via the access node 554 with various application servers and other entities.

The communication system 550 could operate in accordance with a particular radio access technology (RAT), with communications from an access node 554 to UEs 552 defining a downlink or forward link and communications from the UEs 552 to the access node 554 defining an uplink or reverse link. Over the years, the industry has developed various generations of RATs, in a continuous effort to increase available data rate and quality of service for end users. These generations have ranged from “1G,” which used simple analog frequency modulation to facilitate basic voice-call service, to “4G”—such as Long Term Evolution (LTE), which now facilitates mobile broadband service using technologies such as orthogonal frequency division multiplexing (OFDM) and multiple input multiple output (MIMO).

Recently, the industry has been exploring developments in “5G” and particularly “5G NR” (5G New Radio), which may use a scalable OFDM air interface, advanced channel coding, massive MIMO, beamforming, mobile mmWave (e.g., frequency bands above 24 GHz), and/or other features, to support higher data rates and countless applications, such as mission-critical services, enhanced mobile broadband, and massive Internet of Things (IoT). 5G is hoped to provide virtually unlimited bandwidth on demand, for example providing access on demand to as much as 20 gigabits per second (Gbps) downlink data throughput and as much as 10 Gbps uplink data throughput. Due to the increased bandwidth associated with 5G, it is expected that the new networks will serve, in addition to conventional cell phones, general internet service providers for laptops and desktop computers, competing with existing ISPs such as cable internet, and also will make possible new applications in internet of things (IoT) and machine to machine areas.

In accordance with the RAT, each access node 554 could provide service on one or more radio-frequency (RF) carriers, each of which could be frequency division duplex (FDD), with separate frequency channels for downlink and uplink communication, or time division duplex (TDD), with a single frequency channel multiplexed over time between downlink and uplink use. Each such frequency channel could be defined as a specific range of frequency (e.g., in radio-frequency (RF) spectrum) having a bandwidth and a center frequency and thus extending from a low-end frequency to a high-end frequency. Further, on the downlink and uplink channels, the coverage of each access node 554 could define an air interface configured in a specific manner to define physical resources for carrying information wirelessly between the access node 554 and UEs 552.

Without limitation, for instance, the air interface could be divided over time into frames, subframes, and symbol time segments, and over frequency into subcarriers that could be modulated to carry data. The example air interface could thus define an array of time-frequency resource elements each being at a respective symbol time segment and subcarrier, and the subcarrier of each resource element could be modulated to carry data. Further, in each subframe or other transmission time interval (TTI), the resource elements on the downlink and uplink could be grouped to define physical resource blocks (PRBs) that the access node could allocate as needed to carry data between the access node and served UEs 552.

In addition, certain resource elements on the example air interface could be reserved for special purposes. For instance, on the downlink, certain resource elements could be reserved to carry synchronization signals that UEs 552 could detect as an indication of the presence of coverage and to establish frame timing, other resource elements could be reserved to carry a reference signal that UEs 552 could measure in order to determine coverage strength, and still other resource elements could be reserved to carry other control signaling such as PRB-scheduling directives and acknowledgement messaging from the access node 554 to served UEs 552. And on the uplink, certain resource elements could be reserved to carry random access signaling from UEs 552 to the access node 554, and other resource elements could be reserved to carry other control signaling such as PRB-scheduling requests and acknowledgement signaling from UEs 552 to the access node 554.

The access node 554, in some instances, may be split functionally into a radio unit (RU), a distributed unit (DU), and a central unit (CU) where each of the RU, DU, and CU have distinctive roles to play in the access network 556. The RU provides radio functions. The DU provides L1 and L2 real-time scheduling functions; and the CU provides higher L2 and L3 non-real time scheduling. This split supports flexibility in deploying the DU and CU. The CU may be hosted in a regional cloud data center. The DU may be co-located with the RU, or the DU may be hosted in an edge cloud data center.

Turning now to FIG. 6B, further details of the core network 558 are described. In an embodiment, the core network 558 is a 5G core network. 5G core network technology is based on a service based architecture paradigm. Rather than constructing the 5G core network as a series of special purpose communication nodes (e.g., an HSS node, an MME node, etc.) running on dedicated server computers, the 5G core network is provided as a set of services or network functions. These services or network functions can be executed on virtual servers in a cloud computing environment which supports dynamic scaling and avoidance of long-term capital expenditures (fees for use may substitute for capital expenditures). These network functions can include, for example, a user plane function (UPF) 579, an authentication server function (AUSF) 575, an access and mobility management function (AMF) 576, a session management function (SMF) 577, a network exposure function (NEF) 570, a network repository function (NRF) 571, a policy control function (PCF) 572, a unified data management (UDM) 573, a network slice selection function (NSSF) 574, and other network functions. The network functions may be referred to as virtual network functions (VNFs) in some contexts.

Network functions may be formed by a combination of small pieces of software called microservices. Some microservices can be re-used in composing different network functions, thereby leveraging the utility of such microservices. Network functions may offer services to other network functions by extending application programming interfaces (APIs) to those other network functions that call their services via the APIs. The 5G core network 558 may be segregated into a user plane 580 and a control plane 582, thereby promoting independent scalability, evolution, and flexible deployment.

The UPF 579 delivers packet processing and links the UE 552, via the access network 556, to a data network 590 (e.g., the network 560 illustrated in FIG. 6A). The AMF 576 handles registration and connection management of non-access stratum (NAS) signaling with the UE 552. Said in other words, the AMF 576 manages UE registration and mobility issues. The AMF 576 manages reachability of the UEs 552 as well as various security issues. The SMF 577 handles session management issues. Specifically, the SMF 577 creates, updates, and removes (destroys) protocol data unit (PDU) sessions and manages the session context within the UPF 579. The SMF 577 decouples other control plane functions from user plane functions by performing dynamic host configuration protocol (DHCP) functions and IP address management functions. The AUSF 575 facilitates security processes.

The NEF 570 securely exposes the services and capabilities provided by network functions. The NRF 571 supports service registration by network functions and discovery of network functions by other network functions. The PCF 572 supports policy control decisions and flow based charging control. The UDM 573 manages network user data and can be paired with a user data repository (UDR) that stores user data such as customer profile information, customer authentication number, and encryption keys for the information. An application function 592, which may be located outside of the core network 558, exposes the application layer for interacting with the core network 558. In an embodiment, the application function 592 may be execute on an application server 559 located geographically proximate to the UE 552 in an “edge computing” deployment mode. The core network 558 can provide a network slice to a subscriber, for example an enterprise customer, that is composed of a plurality of 5G network functions that are configured to provide customized communication service for that subscriber, for example to provide communication service in accordance with communication policies defined by the customer. The NSSF 574 can help the AMF 576 to select the network slice instance (NSI) for use with the UE 552.

FIG. 7 illustrates a computer system 700 suitable for implementing one or more embodiments disclosed herein. In an embodiment, the UEs 112 and/or the management system 103, etc., may each be implemented as the computer system 700. The computer system 700 includes a processor 382 (which may be referred to as a central processor unit or CPU) that is in communication with memory devices including secondary storage 384, read only memory (ROM) 386, random access memory (RAM) 388, input/output (I/O) devices 390, and network connectivity devices 392. The processor 382 may be implemented as one or more CPU chips.

It is understood that by programming and/or loading executable instructions onto the computer system 700, at least one of the CPU 382, the RAM 388, and the ROM 386 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 700 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as code division multiple access (CDMA), global system for mobile communications (GSM), long-term evolution (LTE), WiFi (IEEE 802.11), Bluetooth, Zigbee, narrowband Internet of things (NB IoT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 384, to the ROM 386, to the RAM 388, and/or to other non-volatile memory and volatile memory of the computer system 700. The processor 382 may process the executable instructions and/or data structures in part by directly accessing the computer program product, for example by reading from a CD-ROM disk inserted into a disk drive peripheral of the computer system 700. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 700.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication network to evaluate a performance of a cell site in a cluttered environment, wherein the method comprises:
identifying, by an application executing at a management system in the communication network, a location of the cell site in the communication network;
determining, by the application, a plurality of zones around the cell site, wherein one or more user equipment (UEs) are located in different zones around the cell site, wherein each of the zones are geographic areas incrementally distanced from the cell site;
obtaining, by the application, a quantity of sessions across one or more UEs located within each of the zones, wherein each of the sessions in the quantity of sessions has a signal attribute value that meets a predefined threshold, wherein the signal attribute value is a reference signal received power (RSRP) value associated with each of the sessions and received from the one or more UEs;
generating, by the application, a vector for the cell site, wherein the vector comprises the quantity of sessions in each of the zones;
computing, by the application, a cosine similarity between the vector for the cell site and a baseline vector to obtain a comparison parameter, wherein the baseline vector includes values associated with a second cell site in a known cluttered environment; and
instructing, by the application, performance of a remediation action based on a rule and on a comparison between the comparison parameter and a predefined threshold, wherein the remediation action comprises transmitting an alarm to an alarm reporting system in the communication network.

2. The method of claim 1, wherein the RSRP value represents an average power level of reference signals received by the one or more UEs from the cell site, and wherein the method further comprises receiving, by the application, the RSRP value from each of the one or more UEs for each of the sessions running at the one or more UEs.

3. The method of claim 1, further comprising determining, by the application, that the cell site is in the cluttered environment when the comparison parameter meets or exceeds the predefined threshold.

4. The method of claim 1, wherein the rule indicates that when the comparison parameter exceeds the predefined threshold, the application is to further instruct a technician to physically examine the cell site and modify the cluttered environment to remove obstacles around the cell site or modify an arrangement of components at the cell site.

5. The method of claim 1, wherein each of the zones are geographic areas incrementally distanced from the cell site according to an incremental distance of 100 meters.

6. The method of claim 1, further comprising presenting, by the application, on a display of the management system, a visual representation of the quantity of sessions in each of the zones having the signal attribute value that meets the predefined threshold, wherein the visual representation comprises a plurality of hexbins overlaying a geographic area corresponding to each of the zones from the cell site, and wherein each of the hexbins displays a visual representation of an average of RSRP values for each session running within the geographic area represented by a respective hexbin.

7. A management system, comprising:
a memory configured to store a baseline vector comprising values representative of a known cell site experiencing signal degradation due to being positioned in a cluttered environment;
a processor coupled to the memory; and
an application stored at the memory, which when executed by the processor, causes the processor to be configured to:
determine, based on a rule, an incremental distance to define a plurality of zones around a cell site, wherein each zone comprises a geographic area extending from the cell site or an outer edge of a previous zone for the incremental distance;
obtain a signal parameter for each zone, wherein the signal parameter is representative of a strength of signals received by one or more user equipment (UEs) from the cell site, wherein each of the one or more UEs are located in different zones around the cell site;
generate a vector for the cell site, wherein the vector comprises the signal parameter for each zone;
obtain a comparison parameter based on a comparison between the baseline vector and the vector for the cell site; and
instruct performance of a remediation action based on whether the comparison parameter meets or exceeds a predefined threshold.

8. The management system of claim 7, wherein the values in the baseline vector each correspond to a prior signal parameter representative of the strength of the signals transmitted by the known cell site experiencing signal degradation due to being positioned in the cluttered environment.

9. The management system of claim 7, wherein each zone extends omnidirectionally and radially away from the cell site or the outer edge of the previous zone for the incremental distance, or radially and directionally from the cell site or the outer edge of the previous zone for the incremental distance.

10. The management system of claim 7, wherein the incremental distance of each zone is 100 meters, wherein each signal parameter for each zone is an average reference signal received power (RSRP) value across each of a plurality of sessions running at each of the one or more UEs in each zone.

11. The management system of claim 7, wherein the signal parameter comprises a quantity of across running at each of the one or more UEs in each zone that has a signal attribute value meeting a first predefined threshold, or wherein the signal parameter comprises a percentage of sessions across running at each of the one or more UEs in each zone that has a signal attribute value meeting a second predefined threshold.

12. The management system of claim 8, wherein the comparison parameter is obtained based on a cosine similarity between the baseline vector and the vector for the cell site.

13. The management system of claim 7, wherein the remediation action comprises at least one of transmitting an alarm to an alarm reporting system, transmitting an instruction to a technician to physically examine the cell site, transmitting an instruction to a technician to modify the cluttered environment to remove obstacles around the cell site, or transmitting an instruction to a technician to modify an arrangement of components at the cell site.

14. A method comprising:
obtaining, by an application executing at a management system, a signal parameter for each of a plurality of zones around a network element, wherein the signal parameter is a value representing of a strength of signals received by one or more user equipment (UEs) from a network element, wherein the one or more UEs are located in different zones around the network element, wherein each of the zones are geographic areas incrementally distanced from the network element;
generating, by the application, a vector for the network element, wherein the vector comprises the signal parameter for each of the zones; and
computing, by the application, a cosine similarity between the vector for the network element and a baseline vector associated with a second network element positioned in a cluttered environment to obtain a comparison parameter and determine a remediation action to perform with respect to the network element based on the comparison parameter.

15. The method of claim 14, wherein the baseline vector comprises values representative of the second network element experiencing signal degradation due to being positioned in the cluttered environment.

16. The method of claim 14, wherein each signal parameter for each zone is an average reference signal received power (RSRP) value across a plurality of sessions running at each of the one or more UEs in each zone.

17. The method of claim 14, wherein the signal parameter comprises a quantity of sessions across running at each of the one or more UEs in each zone that has a signal attribute value meeting a first predefined threshold.

18. The method of claim 14, wherein the signal parameter comprises a percentage of sessions running at each of the one or more UEs in each zone that has a signal attribute value meeting a second predefined threshold.

19. The method of claim 14, wherein the comparison parameter indicates a level of similarity between the vector for the network element and the baseline vector.

20. The method of claim 14, wherein the remediation action comprises at least one of transmitting an alarm to an alarm reporting system, transmitting an instruction to a technician to physically examine the network element, transmitting an instruction to a technician to modify the cluttered environment to remove obstacles around the network element, or transmitting an instruction to a technician to modify an arrangement of components at the network element.
